(19) United States
(12) Patent Application Publication
(10) Pub. No.: US 2012/0244779 A1
(43) Pub. Date: Sep. 27, 2012

(54) OPTICALLY ENHANCED FILMS FOR AEROSTATS

(76) Inventors: Jeffrey Jacob Cernohous, Hudson, WI (US); Neil R. Granlund, Columbia Heights, MN (US); Kent Kaske, Woodbury, MN (US); Adam R. Pawloski, Lake Elmo, MN (US)

(21) Appl. No.: 13/505,825

(22) PCT Filed: Nov. 2, 2010
(86) PCT No.: PCT/US2010/055119

§ 371 Date: May 31, 2012

Related U.S. Application Data
(60) Provisional application No. 61/257,540, filed on Nov. 3, 2009.

(51) Int. Cl. A63H 3/06; B64B 1/58; A63H 27/10; B64B 1/02; B64B 1/14; B64B 1/40; B32B 37/00; B64B 1/00

(52) U.S. Cl. 446/220; 156/60; 244/126; 244/30; 244/31

(57) ABSTRACT

The present invention enhances the optical features of aerostats. The invention utilizes a barrier film having at least one layer containing optically enhancing elements. Aerostats formed from the barrier film possess unique aesthetic features.

### TECHNICAL FIELD

An aerostat utilizing a film with optically modified features to enhance the aesthetics of the aerostat.

### BACKGROUND

Aerostats are objects using principles of aerostatics to float, i.e. lighter than air objects, such as balloons, that derive their lift from the buoyancy of surrounding air rather than from aerodynamic motion. According to Archimedes Principle, an object is buoyed up by a force equal to the weight of the fluid displaced by the object. For an aerostat, the buoyant force must he sufficient enough to overcome the total weight of the aerostat in order to float,

Aerostats generally consist of a relatively thin turn material creating a volumetric body that contains a lighter than air gas to create buoyancy. Aerostats commonly employ helium as a lighter than air gas.

Novelty balloons are an example of aerostats that utilize thin polymeric films to create a volumetric body suitable for containing a lighter than air gas. The thin polymeric films, or barrier films, are employed to contain a majority of the lighter than air gas over time. The barrier films are generally constructed to have a gas barrier layer on a carrier substrate. The barrier film can include a sealant layer as part of the construction of the multilayered film. The sealant layer enables the combination of two separate barrier films to create a volumetric body by heal sealing the periphery of the two films into a desired pattern. The multilayered barrier films are manufactured in a web format with conventional convening practices. The barrier films are optionally printed with fanciful art or greetings, prior to being mated with a second barrier film. The two films are then heat sealed together and the article is cut along a periphery of the sealed area to create the finished article.

### SUMMARY

Bye-catching or attention-grabbing features are highly desirable traits in aerostats due to the aerostats' application or end use. This is particularly true in novelty balloons due to the special nature of the occasions or events in which the balloons are often employed. This disclosure provides various approaches to enhance the optical features of aerostats. The aerostats utilize a barrier film having at least one layer containing optically enhancing elements. Aerostats utilizing the barrier films possess unique and novel aesthetic features. Additionally, the environment in which the aerostats are employed may also enhance the optical features of the resulting aerostat.

A barrier film may be a multilayered film that typically includes a barrier layer, or layers, and optionally a sealant layer. The optically enhancing elements are contained in at least one of the layers of the harrier film, including the optional sealant layer. A barrier film with optically enhancing elements may provide at least a portion or panel of an aerostat in combination with conventional barrier films to define a volumetric body for holding lighter than air gas. Alternatively, a barrier film with optically enhancing elements may serve individually or in combination with another or multiple barrier films with optically enhancing elements to define the volumetric body for holding a lighter than air gas.

The optically enhancing elements are generally dyes, pigments, particles or liquid crystals embedded or dispersed through a layer of the barrier film to impart dynamic aesthetic characteristics to the barrier film and the resulting aerostat, in one embodiment, the optically enhancing elements are contained in the sealant layer. In another embodiment, the optically enhancing elements impart at least one change in appearance based upon a stimulus. The at least one change of appearance may be enabled by the singular use or combination of photochromic, thermochromic, mechanochromic, electrochromic, or chemochromic optically enhancing elements. In certain applications, the change in appearance may generally be reversible.

The aerostats produced utilizing the barrier film containing optically enhancing elements may be made into various forms. Non-limiting examples of aerostats include novelty balloons, a weather balloon, a military balloon, a hot air balloon, an aerostatic game surface, dirigible, blimp, or an exploratory balloon.

The above summary Is not intended to describe each disclosed embodiment or every implementation. The detailed description that follows more particularly exemplifies illustrative embodiments.

### DETAILED DESCRIPTION

A barrier film having at least one layer containing optically enhancing elements may be formed into an aerostat possessing unique and novel aesthetic features. The optically enhancing elements are capable of imparting desirable optical effects or a unique visual appearance to the aerostat. The unique visual appearance may generally be dynamic color effects due to the selected reflection, absorption, emission, scattering, or transmittance of desired wavelengths of light.

Barrier Films

Those of ordinary skill in the an of manufacturing aerostats, such as novelty balloons, recognize that barrier films are necessary to prevent the depletion of the lighter than air gas from the balloon, A barrier film may possess an oxygen gas transmission rate of less than 0.15 cc/100 sq.in./day. The barrier films suitable for use in aerostats may Include, for example, those disclosed in U.S. Pat. Appl. Nos. 2007/0287017 and 2009/0022919. herein incorporated by reference in their entirety.

In one embodiment, the barrier film may be a polyamide a polyester or a polyoiefin based polymer, or combinations of such polymers. For example, a harrier film may he a lamination of a polyester film that includes a biaxially oriented polyester core layer and an amorphous copolyester skin layer. The barrier film may be clear, opaque, or it may be coated with an additional layer, such as a light reflecting layer,

Non-limiting examples of useful polyamide barrier films include nylon 4, nylon 4.6, nylon 6, nylon 6.6, nylon 6.10, nylon 6.12, nylon 11 and nylon 12.

In another embodiment, the barrier film may be a high crystalline polyester film achieved by bi-axial orientation. This crystallized portion of the film may contribute to making the film stiff and tear resistant during the balloon fabrication process, while remaining thin enough to make the aerostat light.

Suitable polyesters include, for example, polymers obtained by polycondensation of a diol and a dicarboxyiic acid. The dicarboxyiic acids may include, for example, terephthalic acid, isophthaiic acid, phthalic acid, naphlhaienedicarboxylic acid, adipic acid and sebacic acid, and the diols may include, for example, ethylene glycol, trimethylene glycol, tetramethylene glycol and cyclohexane dimethanol.

The polyesters may include, for example, polymethylene terephthalate, polyethylene terephthalate, polypropylene terephthalate, polyethylene isophthaiate, polytetramethylene terephthalate, polyethylene-p-oxybenzoate. poly-1,4-cyelohexyIenedimethylene terephthalate and polyethylene-2,6-naphthalate.

These polyesters may be homopolymers and copolymers, and the co-monomers may include, for example, diols such as diethylene glycol, neopentyl glycol and polyalkylene glycols, dicarboxyiic acids such as adipic acid, sebacic acid, phthalic acid, isophthaiic acid and 2,6-naphthalenedicarboxylic acid, and hydroxycarboxylic acids such as hydroxybenzoic acid and 6-hydroxy-2-naphthoic acid.

Polyethylene terephthalate, and polyethylene naphthalate (polyethylene-2,6-naphthalate) may be used to achieve higher crystallinity. Further, the polyester may include various types of additives, for example, an antioxidant, a heat-resistant stabilizer, a weather-resistant stabilizer, an ultraviolet ray absorber, an organic slip agent, a pigment, a dye, organic or inorganic fine particles, a filler, an antistatic agent, a nucleating agent and the like.

In certain embodiments, multiple layer barrier films may be utilized. Multiple layer films may include coextruded layers with at least one layer optionally being an amorphous polymer. Those of ordinary skill in the art are capable of selecting polymeric compositions for multiple layer applications to achieve specific barrier properties.

Non-limiting examples of useful polyoiefin barrier films Include biaxiaily oriented polypropylene and high density polyethylene.

In one embodiment, the multilayered barrier film includes a sealant layer, A sealant layer is generally a bonding composition that enables the broad production of numerous designs and shapes on one mass produced polymeric film. The sealant layer is coated onto the polymeric film in both the crossweb and downweb direction.

Many polymers are known in the art as useful sealants for aerostats. A sealant is typically chosen such that it has adequate adhesion to itself when thermally die cut and welded, to act as a robust balloon seam. The preferred base polymers used to produce the sealants are poly olefins. In one embodiment, base polymers used to produce the sealants are linear low density polyethylene (LLDPE) polymers and copolymers. In another embodiment, copolymers derived from the polymerization of ethylene and alpha-olefins are utilized as base polymers. The alpha-olefin comonomers include linear terminal olefins having between 3 and 20 carbon atoms. Suitable ethylene alpha-olefin copolymers are commercially available from Dow Chemical under the AFFINITY tradename, from Dupont-Dow under the ENGAGE tradename and from Exxon Mobil under tire EXACT or PLASTOMER tradenames. Other Examples of sealant layers include those disclosed in U.S. Pat. Appl. No. 2.009/0022919, herein incorporated by reference in its entirety.

In an alternative embodiment a localized sealant layer may be employed to seal the periphery of two barrier films to create an aerostat. A localized sealant layer eliminates the need for a continuous sealant layer on the barrier film. Localized sealant layers are applied and activated by radiation. The use of localized sealant layers are fully described in U.S. Provisional Appl. No. 61/179.124. herein incorporated by reference in its entirety,

The method of applying an adhesive at the desired point of bonding can be accomplished by coating techniques such as flexographic printing. Inkjet printing, roll transfer, or silk screening. The adhesive is applied about the periphery in most applications after the printing of desired art or greetings and just prior to the point of bonding the two barrier films together, in one embodiment, the adhesive is a radiation curable adhesive, such as a UV curable adhesive. Radiation curable adhesives. upon curing, are capable of achieving substantial bond strengths without excess adhesive material or the creation of large bonding seams, both of which could have negative impacts on the aerostat.

The thickness of the barrier film may range up to about 50 micrometers. The materials of construction for the barrier film, the thickness of the materials employed, the desired shape of the article, should be selected by one of ordinary skill in the art to achieve a desired float time for the aerostat.

Optically Enhancing Elements

The optically enhancing elements are generally dyes, pigments, particles or liquid crystals embedded or dispersed through the barrier film to impart dynamic aesthetic characteristics to the barrier film and the resulting aerostat. A dynamic aesthetic characteristic is a visual change created by (i) external stimulus on the aerostat, or (ii) the change in the angle of observance. The external stimulus may be in the form of the addition or removal of energy. The optically enhancing elements are melt dispersed in the continuous layer and not printed or applied onto an exposed surface of a barrier film. The aesthetic characteristics imparted by the optically enhancing elements generally result from the preferential absorption, emission, transmittance, scatter or reflection of light of one or more wavelengths. The barrier film may be a multilayered film with the optical enhancing elements contained in at least one layer. In one embodiment, the optically enhancing elements are contained in a sealant layer. Specific dyes, pigments, particles, liquid crystals or combinations thereof may be selected to achieve an aerostat with a desired visual effect.

Dyes and pigments are substances of natural or synthetic origin that impart color or other optical effect from the preferential absorption, emission, transmittance, scatter, reflection or refraction of light of one or more wavelengths. Dyes and pigments are substances or compounds that can be incorporated within a substrate or film through a suspension, mixture or other dispersion techniques.

Non-limiting examples of dyes include organic and inorganic compounds and derivatives of acridine, anthraquinone, azin, azo, coumarin, cyanine, diaryImethane, eurhodin, fluorine, iodine, mdophenol, oxazin, phenanthridine, phthalocyauine, quinoline, rhodamine, safranin, thiazin, thiazole, and triaryknethane.

Non-limiting examples of pigments include organic and inorganic compounds and derivatives of allophycocyanin, anthocyanidins, anthocyanins, betalains, carotenoids, chlorophyll, phaeophytin, xanthophyll, and inorganic pigments such as those comprised of aluminum, antimony, arsenic, barium, cadmium, calcium, chromium, cobalt, copper, iodine, iron, lead, mercury, silicon, sodium, sulfur, tin, titanium, and zinc compounds.

Dyes and pigments may exhibit more than one color, allowing transformation from the colorless state to a colored state, either by reversible or irreversible processes. A leuco dye Is one form of a dye or pigment that is capable of achieving two distinct color phases. Typically, one phase is colorless and upon exposure to certain forms of energy, a color phase will emerge. Non-limiting examples of leuco dyes include crystal violet lactone, phenolphthaiein, thymolphthalein, methylene blue, prussian blue, brilliant cresyl blue, toiuidine blue, basic blue 3, methylene green, taylor's blue, janus green, meldoia's blue, thionin, pile blue, and celestfne blue.

Particles may afford enhancements in the aerostat doe to the reflection, absorption, emission, scatter, or transmission of light through the film or may produce a discontinuous dispersion of two or more phases within the film with different optical properties, including differences in refractive index, reflectivity, absorption, or transmission of light Non-limiting examples of particles capable of imparting color or other optical effects by the preferential absorption, emission, reflection, scatter, transmittance or refraction of Light include minerals, polymers, metals, glasses, biological materials or combinations thereof. In certain embodiments., the particles may be microparticles or nanoparticles, Microparticles are generally within tile size range of about one to one thousand micrometers and nanoparticles are generally of the size less than one micrometer.

Microparticles and nanoparticles incorporated into the hairier film may be fabricated by crushing, grinding, pulverizing, dicing, chopping, or otherwise causing a reduction in size from, a material of larger size. In one embodiment, particles are obtained by the chopping of reflective plastic films to produce glitter. In another embodiment, particles are produced by chopping of multilayered films constructed from materials with more than one index of refraction.

In an alternative embodiment, particles may be fabricated from thermal expansion of minerals, most preferable silicon oxides, to produce hollow particles, with the most preferable shape being spherical. Additionally, particles may be fabricated by solution or gas phase chemical reaction. Another non-limiting example includes particles of latex polymer obtained by emulsion polymerization.

Additional examples of useful particles suitable include those produced that encapsulate optically enhancing elements, including dyes, pigments, liquid crystals, or other particles. Particles may be fabricated by microfabrication technologies, such as micromachining, photolithography, imprint lithography, pressing, or milling.

Those of ordinary skill in the art are capable of selecting various methods for making particles compatible with plastic films used to construct aerostats. For example, surface compatibilization agents, surfactants, adhesion promoters, coupling agents, processing aids, block copolymers, and polymer grafts may be used to promote dispersion of particles within the polymer.

In one embodiment, the optically enhancing elements are peariescent particles, often referred to as peariescent pigments, fabricated from mica platelets coated with thin films of titanium dioxide or iron oxides and thermally treated in a calcining process at temperatures in excess of about 535° C. The color of the peariescent particles arises from the interference of light rays reflecting from the top and bottom surfaces of the metal-oxide layer, with the thickness of the coating and the angle of incidence of light rays determining color. In addition, a portion of the light incident onto the peariescent particle is transmitted through the particle providing a color complementary to the reflected color. The observation of color from the peariescent particle depends on the angle at which the particle is viewed, resulting in different effects of iridescence, luminescence, luster, and color. When the angle of observation is changed the peariescent particle may appear to shift colors,

Liquid crystals are substances that exhibit properties between those of isotropic liquids and crystalline solids. Isotropic materials exhibit no long-range order in the alignment of molecules, and crystalline solids exhibit demonstrate long-range order in three dimensions. Liquid crystals may exhibit various mesophases describing the degree and structure of ordering within the material. Those skilled in the art will recognize that the type of mesophase present within the material will determine characteristics of the material's optical properties.

Non-limiting examples of liquid crystals include derivatives of cholesterol, benzidine, azoxybenzene, phenyl ester, carbonate, aniline, clnnamate, Schiff bases, cyanobiphenyl, and liquid crystalline polymers that by the unique properties of the mesogen in their molecular structure, may be capable of producing liquid crystalline phases, such as nematic. smectic, cholesteric, and columnar phases.

In a preferred embodiment, the optically enhancing element comprises a thermochromic cholesteric liquid crystal encapsulated by a polymer.

In one embodiment, the optically enhancing elements may impart at least one change in appearance based upon a stimulus. The stimulus may be in the form of the addition or removal of energy. The at least one change of appearance is enabled by the singular use or combination of photochromic, thermochromic, mechanochromic, electrochromic, or chemochromic optically enhancing elements. In certain applications, the change in appearance may generally be reversible,

Photochromic optically enhancing elements change color or optical properties when stimulated by electromagnetic energy (light). In one embodiment, a photochromic dye. pigment, particle, or liquid crystal Is incorporated into at least one layer of film, with the film remaining clear in the absence of ultraviolet radiation of a particular wavelength, but darkening to become colored upon exposure to ultraviolet radiation. In a certain embodiment, the reversible transformation occurs within a time of less than 60 seconds, more preferably less than 10 seconds.

Thermochromic optically enhancing elements change color or optical properties when stimulated by thermal energy. Those skilled in the art will recognize that thermochromic

materials may be customized to exhibit transformations at temperatures in the range of −20 to 200° C. In one embodiment, the thermochromic optically enhancing element exhibits a reversible and fast conversion from colored to clear at a temperature of 22° C.

Mechanochromic optically enhancing elements change color or optical properties when stintulated by mechanical energy, such as by compression or tension.

In one alternative embodiment, the direction of reflected, scattered, or emitted light from optically enhancing elements dispersed within at least one layer of a barrier film changes as the barrier film is deformed such that the orientation of the dispersed optically enhancing elements is changed with respect to a reference direction. In another embodiment, the optically enhancing elements are microparticies of glitter produced from chopped reflective film and dispersed within the barrier film so that the direction of reflected light changes orientation during deformation by stimulus of mechanical energy, in yet another embodiment, the optically enhancing elements are peariescent pigments, that under deformation of the barrier film from a reference direction by mechanical energy, orients the peariescent pigments In a new direction causing a shift in color as observed from the reference direction.

Electrochromic optically enhancing elements change color or optical properties when stimulated by electrical energy, for example by the application of electrical current or voltage. In one embodiment, an electrochromic optically enhancing element is a colored particle with a surface that exhibits a negative electrical charge, A second electrochromic optically enhancing element is of a different color and exhibits a positive electrical charge. The individual or the combination of two or more electrochromic optically enhancing elements may be incorporated into at least one layer of the barrier film composition. Upon application of electrical voltage across the barrier film composition, the position of the electrochromic optically enhancing element with a negative charge may be changed by aligning its charge with the polarity of the electric field, and if incorporated, the position of the electrochromic optically enhancing element with a positive surface charge will be aligned in the opposite direction. In this manner, the electrochromic optically enhancing element or elements may be aligned within the film to bring one or more colored appearances to the view of an observer,

In another embodiment, the electrochromic optically enhancing element is liquid crystal containing at least one electric dipole and capable of producing at least one mesophase, for which nematic, smectic, and cholesteric phases are non-limiting examples, and incorporated into at least one layer of a barrier film comprising at least one feature capable of polarizing light. By application of an electric field across the barrier film, the electric dipole of the liquid crystal may be aligned to the direction of the electric field, thus providing means to selectively orient the optically enhancing element. Orientation of the optically enhancing element can be used to alter the color, reflection, absorption, transmission, scatter, emission, or index of refraction of the optically enhancing element with respect to an observer.

Chemochromic optically enhancing elements change color or optical properties when stimulated by chemical energy, non-limiting examples including chemical reaction, change in pH, and solvent conditions.

Those skilled in the art will appreciate the use of additives, such as antioxidants, adhesion promoters, acid or base stabilizers, activators, solubilizers, sensitizers, fixation agents, or synergists to improve or enhance the attachment, incorporation, appearance or performance of the dye, pigment, particle, or liquid crystal with respect to a film.

The optically enhancing elements are embedded or dispersed within the barrier film. Conventionally recognized methods for the distribution of dyes, pigments, particles or liquid crystals in a film are suitable for embedding or dispersing the optically enhancing elements. In one embodiment the concentration of optically enhancing elements is In the range of 0.05 to 30 wt %, and may be in the range of 0.1 to 8 wt %.

The aerostat, and in particular balloons for novelty applications, may optionally include aesthetic layer(s), such as, graphics, reflective layers, indicia, print, fanciful art or alphanumeric characters applied onto an exposed surface of the article. Flexographic printing is one means for applying such aesthetic layer or layers. The printing equipment used in this process may be set up in a manner that will prevent scratching, scuffing or abrading the barrier surface.

Conventionally recognized valves suitable for the insertion of a lighter than air gas may be employed in conjunction with the aerostat. For example, self-sealing, flexible valves such as those described in U.S. Pat. No. 4,917,646 and U.S. application Ser. No. 12/079,799, both herein incorporated by reference in their entirety, may be utilized. Those of ordinary skill in the art are capable of selecting a particular valve depending upon the desired application.

The aerostats may be produced using conventional cutting and sealing practices, For example, for large scale production for articles such as novelty balloons, the fabrication of such an aerostat may be accomplished in a web format. Two or more webs of barrier film are generally positioned to align any desirable aesthetic features, such as graphics, then adhered to another about a desired periphery by a sealing mechanism. The article is then cut or slit around, or near, the sealed periphery into desired shapes, A valve is typically inserted between the webs prior to sealing to provide subsequent inflation. The volumetric body created by the sealed periphery is capable of receiving and holding a gas.

In certain embodiments, the aerostats may have an oxygen transmission rate of less than 0.15 cc/100 sq. in/day, a sealing strength of the seam on the aerostat of more than 1000 g/in, and a floating time of the article in air at standard sea level conditions is more than 48 hours. Additionally, certain embodiments may result in relatively small volumetric designs such as aerostats having an internal volume of less than about 2000 cm³, particularly those that embody a localized sealant.

Oxygen transmission rates are measured using a MOCON Ox-Tran L series device utilizing ASTM D3985 with test conditions of 73° F. and 0% RH at 1 ATM.

Seal strength uses a modified ASTM F88 test standard. The sealed materials are cut so that each web can be gripped in a separate jaw of the tensile tester and 1″×⅜″ section of sealed material can be peeled apart on an Instron tensile tester in an unsupported 90° configuration. Initial grip separation is at 4 inches with a preload rate of 2 in/min until 0.5 lbs of resistance is reached. Tensile force is continued at a rate of 6 in/rain until the load drops by 20% of the maximum load, signaling failure. The maximum recorded load prior to failure is reported as the seal strength.

Floating time of the aerostat is determined by inflating it with helium gas and measuring the number of days that the aerostat remains fully inflated. An aerostat is filled from a helium source using a pressure regulated nozzle designed for “foil” balloons, such as the Comvin Precision Pius balloon inflation regulator and nozzle, The pressure should be regulated to 16 inches of water column pressure with an auto shut off. The aerostat should be filled with helium in ambient conditions of about 21° C. temperature until the internal pressure of the aerostat reaches 16 inches of water column and the regulator shuts off. The aerostat should be tethered below the aerostat's valve access hole to avoid distorting or damaging the valve thus creating slow leaks of helium gas through the valve. During the testing the aerostat should be kept in a stable environment close to the ambient conditions stated. Changes in temperature and barometric pressure should be recorded to interpret float time results, as any major fluctuations can invalidate the test. The aerostat is observed over the course of the test for the appearance of fullness. One judgment criteria used is when the appearance of the aerostat changes so that the wrinkles become deeper and longer, extending into the front face of the aerostat; and the cross-section of the seam becomes a v-shape, as opposed to the rounded shape that characterizes a fully inflated aerostat. At this time the aerostat will still physically float but will no longer have an aesthetically pleasing appearance. The number of days between, initial inflation and the loss of aesthetic appearance described above is reported as the floating time of the aerostat.

The aerostats produced utilizing the barrier layer containing optically enhanced elements may be made into various forms. Non-limiting examples of aerostats include novelty balloons, a weather balloon, a military balloon, a hot air balloon, an aerostatic game surface, dirigible, blimp, or an exploratory balloon.

Those of ordinary skill in the art of producing novelty balloons recognize that an article possessing optically enhancing elements in novelty balloon applications may employ air instead of lighter than air gases to create an aesthetic balloon. For example, it is often customary to affix novelty balloons filled with air to structures or articles for decorative purposes. Aesthetic balloons with optically enhancing elements may be desirable for such decorative applications.

### EXAMPLES

TABLE 1
Material Key for Examples

| MATERIAL | DESCRIPTION |
|---|---|
| Resin 1 | XP292 Clear Resin—an ethylene-octene copolymer |
| | resin blend available from Interfacial Solutions, LLC |
| | (River Falls, WI) |
| Resin 2 | Affinity PT 14500G1 resin from Dow Chemical |
| | (Midland, MI) |
| Pigment | PX1241 Phoenix branded pearlescent pigment from |
| | ECKART America Corporation (Louisville, KY) |
| Cholesterol | C8503 from Sigma Aldridge (Milwaukee, WI) |
| Pigment 1— | Thermochromic dark green pigment from LCR |
| Thermochromic | Hallcrest (Glenview, IL) |
| Pigment 2— | Reversacol branded palentine purple pigment from |
| Photochromic | James Robinson Ltd (West Yorkshire, England) |

Compounding the Resin and the Optically Enhancing Element

The resin and optically enhancing elements for each respective example were fed using two volumetric feeders into a 27 mm co-rotating twin screw extruder (32:1, L:D) titled with a three strand die (commercially available from American Leistritz Extruder Corporation. Nommerville, N.J.). All examples were processed at 150 rpm screw speed using the following temperature profile: Zone 1−2=70° C. Zone 3−4=175° C. Zone 5−6=180° C. Zone 7−8=180° C. Die=180° C. The resulting strands were subsequently air cooled in and pelletized into 0.64 cm pellets.

Blown Film Extrusion Studies—Examples 1-4.

The compounded resin for each example, as set forth in Table 2, was gravity fed into a 1.9 cm single screw extruder (commercial available from C. W. Brabender, South Hackensack, N.J.) fitted with a blown film die and take off unit The die had a 0.05 cm gap. All samples were processed at 50 rpm screw speed and a torque in the range of 28-32% using the following temperature profile: Zone 1=145° C. Zone 2=190° C. Zone 3=190° C. Zone 4=190° C. The resulting film was analyzed for color and surface quality and then subjected to either a stimulus or change in the angle of observance to determine color changes.

TABLE 2
FORMULATIONS FOR EXAMPLES 1-4

| | | | Choles- | Pigment - | Pigment - |
|---|---|---|---|---|---|
| EXAM- | Resin | Pigment | terol | thermochromic | photochromic |
| PLE | (wt %) | (wt %) | (wt %) | (wt %) | (wt %) |
| 1 | 94 | 6 | — | — | — |
| 2 | 98 | — | 2 | — | — |
| 3 | 90 | — | — | 10 | — |
| 4 | 99.8 | — | — | — | 0.2 |

Compounding The Resin And Optically Enhancing Element—Example 5

Polymer compositions were compounded info a mixture by melt processing using a 26 mm twin-screw extruder (Labtech Engineering. Bangkok. Thailand) at 180° C. Formulations contained 0.2% by weight of Pigment 2 were produced in Resin 2. The materials were blended by extrusion, formed mto a strand through a die. cooled in air and pelktized.

Cast Film Extrusion Examples—Examples 6 and 7

The pelletized formulations of Example 5 were used to produce thin films by casting. A 32 mm single-screw extruder (Davis Standard, Pawcatuck, Conn.) was used to melt the plastic pellets and extrude the molten material through a film die (Killion-Davis Standard, Pawcatuck, Conn.) with a 45 cm slit opening. The films were processed using an ascending heat profile from 21.8° C. in the extruder to 277° C. at the die. The extrudate was pressed between a silicone nip roller and a mirror finish chill roll that was held at 70° F. by an external chiller. For Example 6, the rotational speed of the chill roller and the speed of the motorized take off unit were adjusted to produce a film of about 0.02 mm thick. For Example 7, a coated layer of about 0.02 mm thick was extruded onto a moving carrier of polyoiefin. While in the molten state during extrusion, the films displayed a low intensity of color. After cooling and without exposure to ultraviolet light, the films were transparent and visually colorless. When exposed to outdoor sunlight or a high intensity 390 nm LED light source (Dynatronix, Avery, Wis.), the films immediately turned purple in color and darkened. The exposure to ultraviolet light was stopped and the films returned to their initial colorless state.

Mock Up Of A Novelty Balloon—Example 8

The film of Example 6 was folded over onto itself with the two matte surfaces resulting from contact with the nip roller in direct contact with each other. The smooth surfaces resulting from contact with the mirror finish chill roll were exposed on either side of the folded film. A silhouette of a two-dimensional balloon shape was placed on the smooth surface of one side of the folded film. An Iron was then used to trace around the periphery of the silhouette, with the exception of the stern portion. The heat from the iron created a seal in the folded film corresponding to the periphery of the silhouette. The folded film was then hand cut around the edges of the seal to create a conventional balloon shaped article. The balloon shaped article was filled with a lighter than air gas at the open stem portion. The stem was then folded over onto Itself to create a temporary seal.

From the above disclosure of the general principles and the preceding detailed, description, those skilled in this art will readily comprehend the various modifications to which the present Invention is susceptible. Therefore, the scope of the invention should be limited only by the following claims and equivalents thereof.

1. An article comprising a barrier film having at least one layer containing an optically enhancing element, the barrier film formed into an aerostat.

2. An article according to claim 1, wherein the at least one layer containing the optically enhancing element is a sealant layer.

3. An article according to claim 1, wherein the optically enhancing element is selected from dyes, pigments, particles, liquid crystals, and combinations thereof.

4. An article according to claim 3, wherein the dyes include organic and inorganic compounds and derivatives of acridine, anthraquinone, azin, azo, coumarin, cyanine, diarylmethane, eurhodin, fluorine, iodine, indophenol, oxazin, phenanthridine, phthalocyanine, quinoline, rhodamine, safranin, thiazin, thiazole, triarylmethane or combinations thereof.

5. An article according to claim 3, wherein particles include minerals, polymers, metals, glasses, biological materials or combinations thereof.

6. An article according to claim 3, wherein the liquid crystals include at least one electric dipole and is capable of producing at least one mesophase.

7. An article according to claim 3, wherein the pigments are compounds or derivatives of allophycocyanin, anthocyanidins, anthocyanins, betalains, carotenoids, chlorophyll, phaeophytin, xanthophyll, or inorganic derivatives of aluminum, antimony, arsenic, barium, cadmium, calcium, chromium, cobalt, copper, iodine, iron, lead, mercury, silicon, sodium, sulfur, tin, titanium, zinc compounds or combinations thereof.

8. An article according to claim 1, wherein the optically enhancing element is capable of imparting at least one change in appearance of the aerostat based upon a stimulus.

9. An article according to claim 8, wherein the optically enhancing element is photochromic, thermochromic, mechanochromic, electrochromic, chemochromic or combinations thereof.

10. An article according to claim 8, wherein the change of appearance of the aerostat is reversible.

11. An article comprising a first barrier film having at least one melt processable layer containing optically enhancing elements, and a second barrier film sealed to the first barrier film to form an aerostat.

12. An article according to claim 11, wherein the at least one layer containing the optically enhancing element is a sealant layer.

13. An article according to claim 11, wherein the optically enhancing element is selected from dyes, pigments, particles, liquid crystals, and combinations thereof.

14. An article according to claim 11, wherein the second barrier film has at least one melt processable layer containing optically enhancing elements.

15. An article according to claim 1, wherein the aerostat is a novelty balloon, a weather balloon, a military balloon, a hot air balloon, a game, dirigible, blimp, or an exploratory balloon.

16. An article comprising an optically enhanced barrier film containing optically enhancing elements, and at least one secondary barrier film, wherein the optically enhanced barrier film and the at least one secondary barrier film are sealed together to create a volumetric body capable of receiving and holding a gas.

17. An article according to claim 16, wherein the volumetric body is inflated with air or a lighter than air gas.

18. A method comprising forming an aerostat from a barrier film having at least one layer containing an optically enhancing element.

19. A method according to claim 18, wherein the barrier film is sealed to a secondary barrier film to form the aerostat.

20. A method according to claim 19, wherein the secondary barrier film has at least one layer containing optically enhancing elements.
